(19) United States
(12) Patent Application Publication
(10) Pub. No.: US 2019/0237736 A1
(43) Pub. Date: Aug. 1, 2019

(54) POWER STORAGE DEVICE

(71) Applicant: Toyota Jidosha Kabushiki Kaisha, Toyota-shi Aichi-ken (JP)

(72) Inventors: Kenta Watanabe, Toyota-shi Aichi-ken (JP); Nobuyoshi Fujiwara, Nagoya-shi Aichi-ken (JP); Koichi Umeda, Nagoya-shi Aichi-ken (JP)

(73) Assignee: Toyota Jidosha Kabushiki Kaisha, Toyota-shi Aichi-ken (JP)

(21) Appl. No.: 16/257,316

(22) Filed: Jan. 25, 2019

(30) Foreign Application Priority Data
Jan. 30, 2018 (JP) 2018-013640

(51) Int. Cl. H01M 2/20; H01M 10/48; H01M 2/26; H01M 2/30; H01M 2/10; H01R 11/28

(52) U.S. Cl. CPC H01M 2/206; H01M 10/482; H01M 2/26; H01M 2220/20; H01M 2/1077; H01R 11/288; H01M 2/30

(57) ABSTRACT

A power storage device includes: an electrode cell including a first electrode and a second electrode; a first electrode bus bar connected to the first electrode; a second electrode bus bar connected to the second electrode; and a connection member connected to the first electrode bus bar and joined to the second electrode bus bar. The connection member includes a body portion connected to the first electrode bus bar and joined to the second electrode bus bar, and an extension piece provided so as to extend from the body portion. The extension piece is folded from the body portion.

### CROSS-REFERENCE TO RELATED APPLICATIONS

This application claims priority to Japanese Patent Application No. 2018-013640 filed on Jan. 30, 2018, which is incorporated herein by reference in its entirety.

### BACKGROUND

### 1. Technical Field

This disclosure relates to a power storage device.

### 2. Description of Related Art

Various power storage devices including a plurality of power storage cells have been proposed in the related art. A power storage device described in Japanese Unexamined Patent Application Publication No. 2005-116456 (JP 2005-116456 A) includes a plurality of power storage cells and a plurality of frames in which the power storage cells are provided.

The power storage cell is formed in a rectangular and flat shape. A first short side of the power storage cell is provided with a positive electrode tab, and a second short side thereof is provided with a negative electrode tab.

The frame is configured such that four power storage cells are arranged in one direction. The frame is provided with a support frame for supporting outer peripheries of the power storage cells, and their positive electrode tabs and negative electrode tabs are placed on the support frame. The four power storage cells placed on the frame are provided such that their positive electrode tabs and negative electrode tabs are arranged alternately on the support frame. A positive electrode tab and a negative electrode tab adjacent to each other are connected via a conductive member.

A first end of the conductive member is welded to the positive electrode tab by ultrasonic welding, and a second end of the conductive member is welded to the negative electrode tab by ultrasonic welding. A bending portion bent so as to project upward is provided in the central part of the conductive member.

In the power storage device, when the second end of the conductive member is welded to the negative electrode tab by ultrasonic welding after the first end of the conductive member is welded to the positive electrode tab, the bending portion restrains vibrations caused on the second end side from being transmitted to the positive electrode tab side.

### SUMMARY

As the power storage device, there has been known a power storage device including a plurality of cylindrical cells, a plate-shaped holder, a positive bus bar, a negative bus bar, and a connection member.

The holder is provided with a plurality of insertion holes so that the cylindrical cells are inserted into the insertion holes. The cylindrical cell inserted into the insertion hole is configured such that a positive electrode is positioned in its upper end and a negative electrode is positioned in its bottom end.

The positive bus bar is placed on the upper end side of the cylinder cell and the negative bus bar is placed on the bottom end side of the cylindrical cell. The positive bus bar is provided with a plurality of positive terminal wiring lines so that the positive terminal wiring lines are connected to the positive electrodes of the cylindrical cells, and the negative bus bar is provided with a plurality of negative terminal wiring lines so that the negative terminal wiring lines are connected to the negative electrodes of the cylindrical cells.

The connection member connects the positive bus bar to the negative bus bar and the connection member is formed in a plate shape.

When the connection member is connected to the positive bus bar, ultrasonic welding is performed such that a lower end of the connection member and a welding portion of the negative bus bar are pressed in a state where they overlap with each other and vibrations are applied to the overlap portion.

At this time, the vibrations applied to the overlap portion might be transmitted to the positive terminal wiring lines via the connection member and the positive bus bar. The positive terminal wiring lines are thin, and therefore, when the vibrations are applied to the positive terminal wiring lines, the positive terminal wiring lines might crack or the positive terminal wiring lines might break. As such, when the positive bus bar vibrates, various adverse effects might occur in a connection state between the positive bus bar and the cylindrical cells.

Even if the bent portion is provided in the connection member like the connection member described in JP 2005-116456 A, vibrations caused in the connection member cannot be reduced sufficiently, so that similar adverse effects might occur.

Note that the above description deals with a problem caused when ultrasonic welding is performed to weld, to the negative bus bar, the connection member connected to the positive bus bar, but similar adverse effects might occur in a connection state between the negative bus bar and the cylindrical cells when ultrasonic welding is performed to weld, to the positive bus bar, the connection member connected to the negative bus bar.

This disclosure is accomplished in view of the above problems and provides a power storage device in which various adverse effects such as poor connection between a bus bar and a battery cell are restrained.

A power storage device of the disclosure includes an electrode cell, a first electrode bus bar, a second electrode bus bar, and a connection member. The electrode cell includes a first electrode and a second electrode. The first electrode bus bar is connected to the first electrode. The second electrode bus bar is connected to the second electrode. The connection member is connected to the first electrode bus bar and joined to the second electrode bus bar. The connection member includes a body portion connected to the first electrode bus bar and joined to the second electrode bus bar, and an extension piece provided so as to extend from the body portion. The extension piece is folded from the body portion.

With the power storage device, even if vibrations are applied to the connection member at the time when the connection member is joined to the second electrode bus bar, it is possible to restrain the vibrations transmitted from the connection member to the first electrode bus bar. This makes it possible to restrain an effect on a connection state between the first electrode bus bar and the first electrode.

In the power storage device, the extension piece may be folded so as to overlap with the body portion. With the power storage device, it is possible to further reduce the vibrations transmitted from the connection member to the first electrode bus bar.

Further, in the power storage device, the first electrode bus bar may include a first terminal wiring line connected to the first electrode. The second electrode bus bar may include a second terminal wiring line connected to the second electrode. The connection member may be integrally connected to the first electrode bus bar. Furthermore, a sectional area of the first terminal wiring line may be smaller than a sectional area of the second terminal wiring line. A thickness of the connection member may be thinner than a thickness of the second electrode bus bar.

With the power storage device, the connection member can hardly vibrate, so that it is possible to reduce the vibrations transmitted from the connection member to the first electrode bus bar at the time of joining, thereby making it possible to restrain adverse effects such as breaking of the thin first terminal wiring line.

Further, in the power storage device, the body portion may include a first lateral side and a second lateral side. The extension piece may include a first piece portion and a second piece portion. The first piece portion may be connected to the first lateral side and provided so as to extend from the first lateral side. The second piece portion may be connected to the second lateral side and provided so as to extend from the second lateral side.

With the power storage device, it is possible to restrain the vibrations transmitted from the connection member to the first electrode bus bar at the time when the connection member is joined to the second electrode bus bar.

With the power storage device of this disclosure, various adverse effects such as poor connection between a bus bar and a battery cell can be restrained.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic view schematically illustrating a vehicle in which a power storage device of an embodiment of the disclosure is provided;

FIG. 2 is a perspective view schematically illustrating a power storage unit included in the power storage device;

FIG. 3 is an exploded perspective view schematically illustrating a power storage module illustrated in FIG. 2;

FIG. 4 is a perspective view illustrating a positive bus bar and a connection member included in the power storage module;

FIG. 5 is a perspective view illustrating a hole provided in the positive bus bar and its peripheral configuration;

FIG. 6 is a bottom view of the connection member when it is viewed from the lower side;

FIG. 7 is a perspective view illustrating the positive bus bar and the connection member in a state where the connection member is developed;

FIG. 8 is a bottom view of the connection member in the state illustrated in FIG. 7 when it is viewed from the lower side;

FIG. 9 is a bottom view illustrating a negative bus bar module illustrated in FIG. 3;

FIG. 10 is a plan view illustrating a part of a negative bus bar included in the negative bus bar module;

FIG. 11 is a sectional view illustrating a part of the power storage module illustrated in FIG. 2;

FIG. 12 is a sectional view illustrating a joining piece and a joining piece included in the power storage module illustrated in FIG. 11;

FIG. 13 is a front view illustrating the joining piece and the joining piece;

FIG. 14 is a sectional view illustrating a step of welding the joining piece to the joining piece;

FIG. 15 is a graph illustrating a result of measurement of an amplitude of vibration at each measurement point when various positive bus bars are welded to a joining piece by ultrasonic welding;

FIG. 16 is a perspective view illustrating the connection member;

FIG. 17 is a bottom view of the connection member illustrated in FIG. 16 when it is viewed from the lower side;

FIG. 18 is a perspective view illustrating a connection member that is not provided with a piece portion;

FIG. 19 is a bottom view of the connection member that is not provided with the piece portion when it is viewed from the lower side;

FIG. 20 is a graph illustrating a relationship between the magnitude of a piece portion in various shapes and its vibration prevention effect;

FIG. 21 is a perspective view illustrating a connection member;

FIG. 22 is a sectional view illustrating a power storage device as a modification of the power storage device of the present embodiment;

FIG. 23 is a perspective view illustrating a positive bus bar, a connection member, and a negative bus bar of the power storage device of the modification; and

FIG. 24 is a perspective view illustrating a connection member of a further modification of the connection member of the power storage device of the modification.

### DETAILED DESCRIPTION

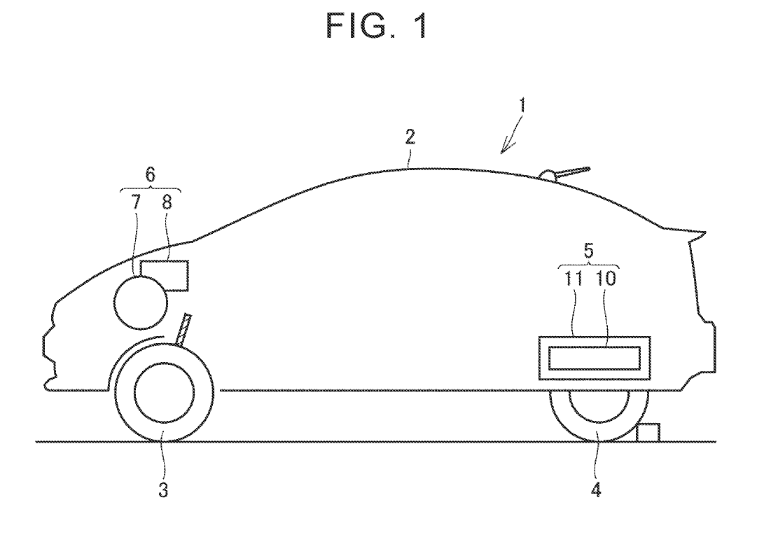

With reference to FIGS. 1 to 24, the following describes a power storage device of the present embodiment. Among constituents illustrated from FIGS. 1 to 24, the same constituent or substantially the same constituent has the same reference sign and a description thereof is omitted.

FIG. 1 is a schematic view schematically illustrating a vehicle 1. The vehicle 1 includes a vehicle body 2, front wheels 3, rear wheels 4, a power storage device 5, and a driving device 6.

In the vehicle body 2, a cabin space, an engine compartment, and a luggage room are provided. A plurality of seats is accommodated in the cabin space and the cabin space is a space where a driver and an occupant get in. The engine compartment is provided in front of the cabin space. The luggage room is provided behind the cabin space and is a space where luggage and the like are accommodated.

The driving device 6 is accommodated in the engine compartment. The driving device 6 includes a rotary electric machine 7 and a power control unit (PCU) 8. The PCU 8 includes a converter and an inverter.

The inverter is electrically connected to the rotary electric machine 7 and the power storage device 5. The inverter boosts up a direct-current power supplied from the power storage device 5 and then converts the direct-current power into an alternating-current power, so as to supply the alternating-current power to the rotary electric machine 7. The rotary electric machine 7 is mechanically connected to the front wheels 3. The rotary electric machine 7 is driven by the alternating-current power supplied from the PCU 8 and generates a driving force to rotate the front wheels 3 as driving wheels.

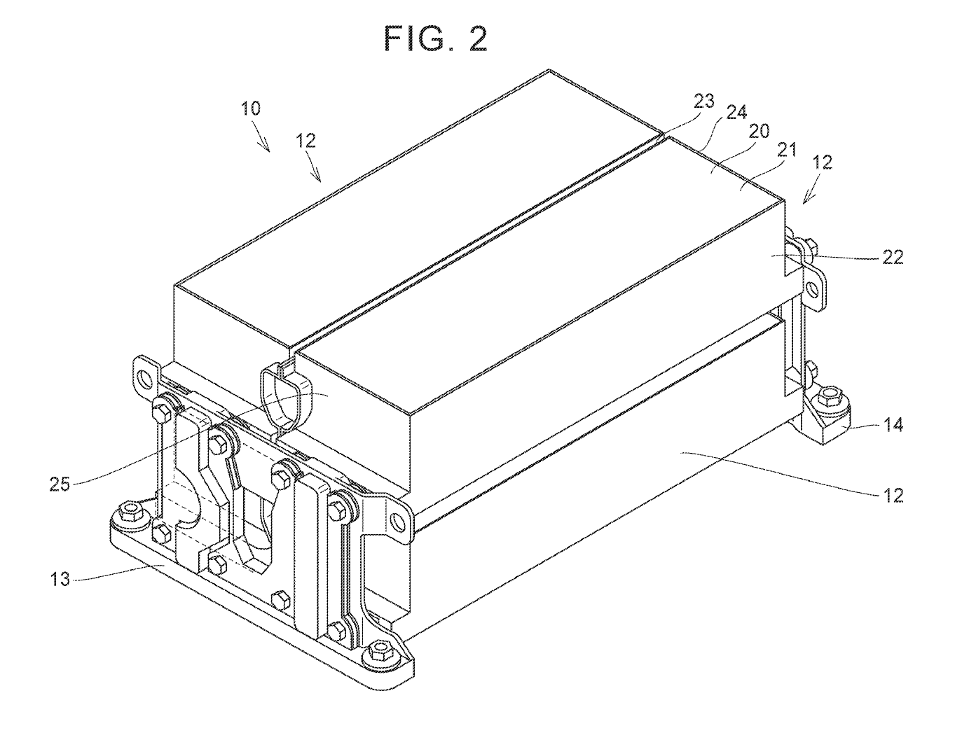

The power storage device 5 includes a power storage unit 10 and a housing case 11. FIG. 2 is a perspective view schematically illustrating the power storage unit 10.

The power storage unit 10 includes a plurality of power storage modules 12 and end plates 13, 14. The end plate 13 is provided on a first lateral face side of the power storage unit 10 and the end plate 14 is provided on a second lateral face side of the power storage unit 10.

The end plates 13, 14 are fixed to a floor panel or the like of the vehicle body 2, for example.

The power storage modules 12 are fixed to the end plates 13, 14. The power storage module 12 has a generally rectangular solid shape. The power storage module 12 includes an outer case 20. The outer case 20 includes a cover 21, side walls 22, 23, and end walls 24, 25.

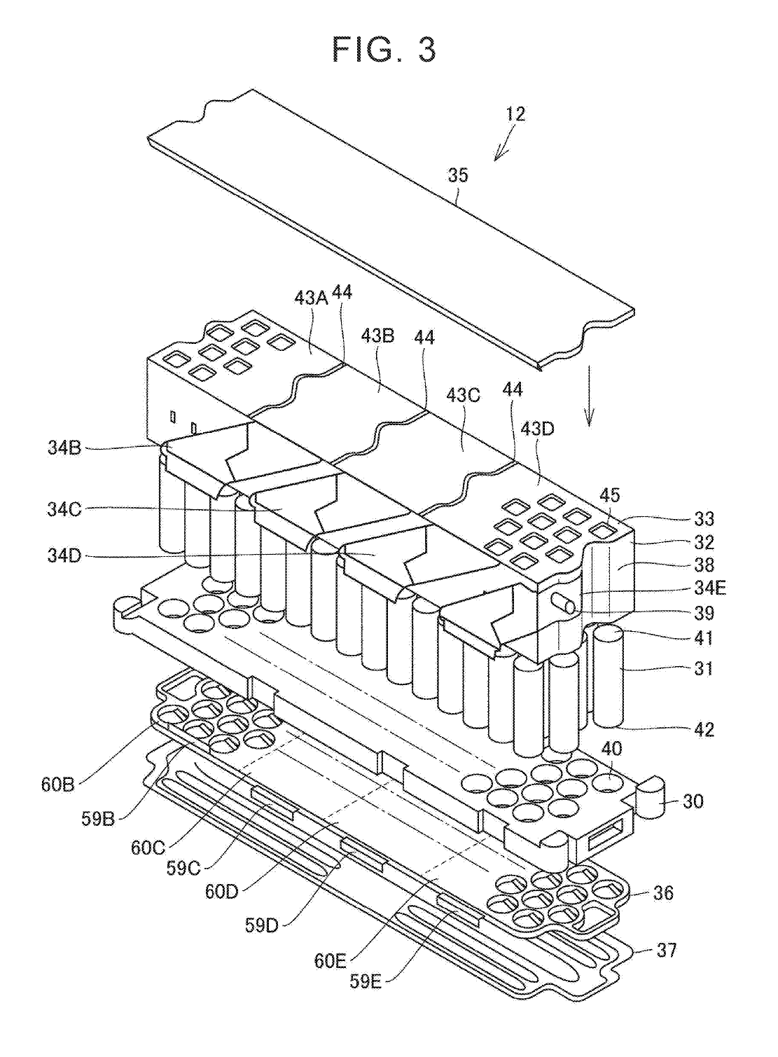

FIG. 3 is an exploded perspective view schematically illustrating the power storage module 12. The power storage module 12 includes a holder 30, a plurality of cylindrical cells 31, an inner case 32, a positive bus bar module 33, a plurality of connection members 34B, 34C, 341D, 34E, a negative bus bar module 36, and a bottom cover 37.

The holder 30 is made of a metallic material. A plurality of insertion holes 40 is provided in the holder 30. The cylindrical cells 31 are inserted into the insertion holes 40. Note that an insulating member is provided on inner peripheral surfaces of the insertion holes 40 so that insulating properties between the cylindrical cells 31 and the holder 30 are secured.

An upper end of the cylindrical cell 31 projects upward from the top face of the holder 30. The cylindrical cell 31 includes a positive electrode 41 and a negative electrode 42. The positive electrode 41 is provided in an upper end of the cylindrical cell 31 and the negative electrode 42 is provided in a bottom end of the cylindrical cell 31.

The inner case 32 is placed on the top face of the holder 30 and is provided so as to cover the cylindrical cells 31 from the upper side. An opening that is opened downward is provided in the inner case 32. The inner case 32 includes a peripheral wall portion 38 and an upper wall portion. The peripheral wall portion 38 is provided so as to extend downward from an outer peripheral edge of the upper wall portion. The peripheral wall portion 38 is formed annularly along the outer peripheral edge of the upper wall portion. Note that, in the state illustrated in FIG. 3, the positive bus bar module 33 is placed on the top face of the upper wall portion, and the upper wall portion is not illustrated. The inner case 32 is made of an insulation material such as resin.

The positive bus bar module 33 is placed on the top face of the upper wall portion of the inner case 32. The positive bus bar module 33 includes a plurality of positive bus bars 43A, 43B, 43C, 43D. A gap 44 is provided between adjacent positive bus bars among the positive bus bars 43A, 43B, 43C, 43D. A plurality of holes 45 is provided in each of the positive bus bars 43A, 43B, 43C, 43D.

The connection members 34B, 34C, 34D, 34E are placed on a lateral face of the inner case 32. An upper end of the connection member 34B is connected to the positive bus bar 43B and a lower end of the connection member 34B is joined (by ultrasonic welding) to a joining piece 59B of the negative bus bar module 36 (described later).

Similarly, respective upper ends of the connection members 34C, 34D, 34E are connected to the positive bus bars 43C, 43D, 43E. Respective lower ends of the connection members 34C, 34D, 34E are joined by ultrasonic welding to joining pieces 59C, 59D, 59E of the negative bus bar module 36.

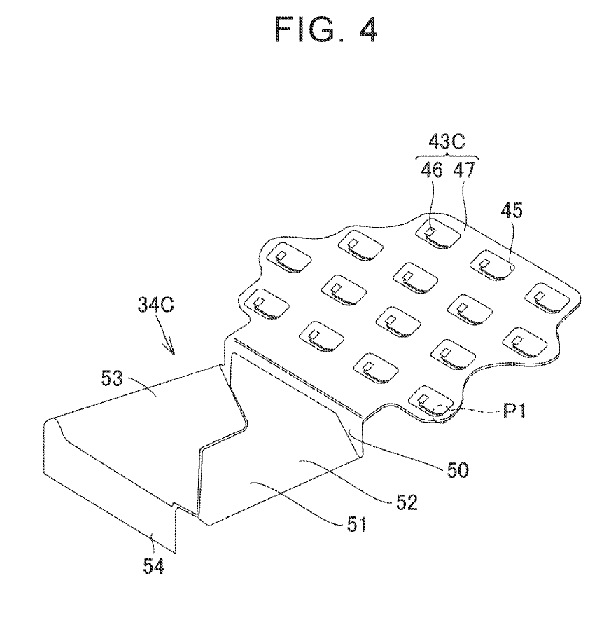

FIG. 4 is a perspective view illustrating the positive bus bar 43C and the connection member 34C. The positive bus bar 43C is formed in a plate shape. The connection member 34C is integrally connected to a lateral side of the positive bus bar 43C and the connection member 34C is provided so as to extend downward from the lateral side of the positive bus bar 43C.

The positive bus bar 43C is made of aluminum or aluminum alloy, for example. The positive bus bar 43C includes a bus bar body 47 formed in a plate shape and a plurality of terminal wiring lines 46. The holes 45 are provided in the bus bar body 47 so that the terminal wiring lines 46 are provided in the holes 45.

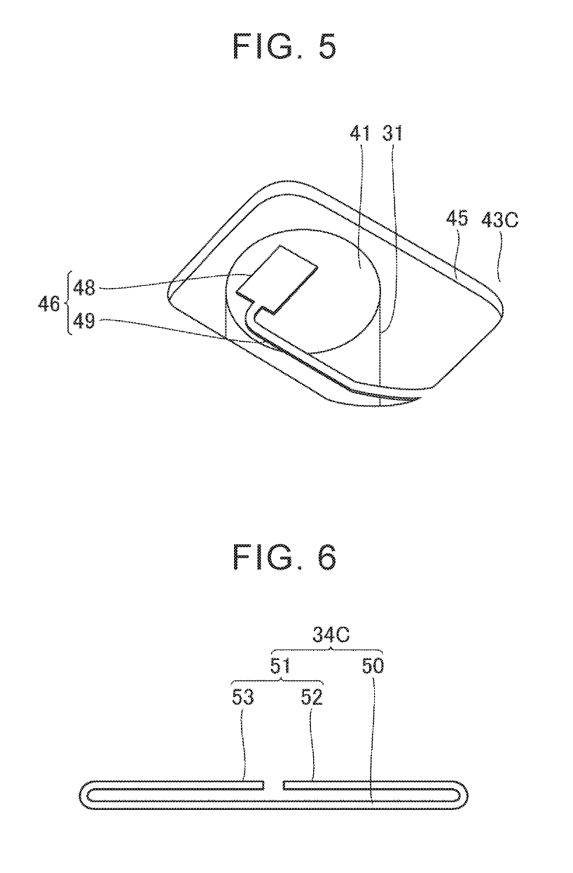

FIG. 5 is a perspective view illustrating the hole 45 and its peripheral configuration. The terminal wiring line 46 includes a pedestal 48 and a wiring line 49. The pedestal 48 is welded to the positive electrode 41 of the cylindrical cell 31. The wiring line 49 connects the pedestal 48 to an inner peripheral surface of the bus bar body 47 where the hole 45 is provided.

The terminal wiring line 46 formed as such is provided in each of the holes 45, so that the positive bus bar 43C electrically connects the positive electrodes 41 of the cylindrical cells 31 in parallel to each other. Note that wire bonding may be employed as the terminal wiring line 46.

Referring back to FIG. 4, the connection member 34C is formed integrally with the positive bus bar 43C and is provided so as to extend downward by folding from the lateral side of the positive bus bar 43C.

FIG. 6 is a view schematically illustrating a bottom view of the connection member 34C when it is viewed from the lower side. With reference to FIGS. 6 and 4, the connection member 34C includes a body portion 50 and an extension piece 51. The extension piece 51 is provided so as to extend from a lateral side of the body portion 50. The extension piece 51 includes a piece portion 52 connected to a first lateral side of the body portion 50 and a piece portion 53 connected to a second lateral side thereof.

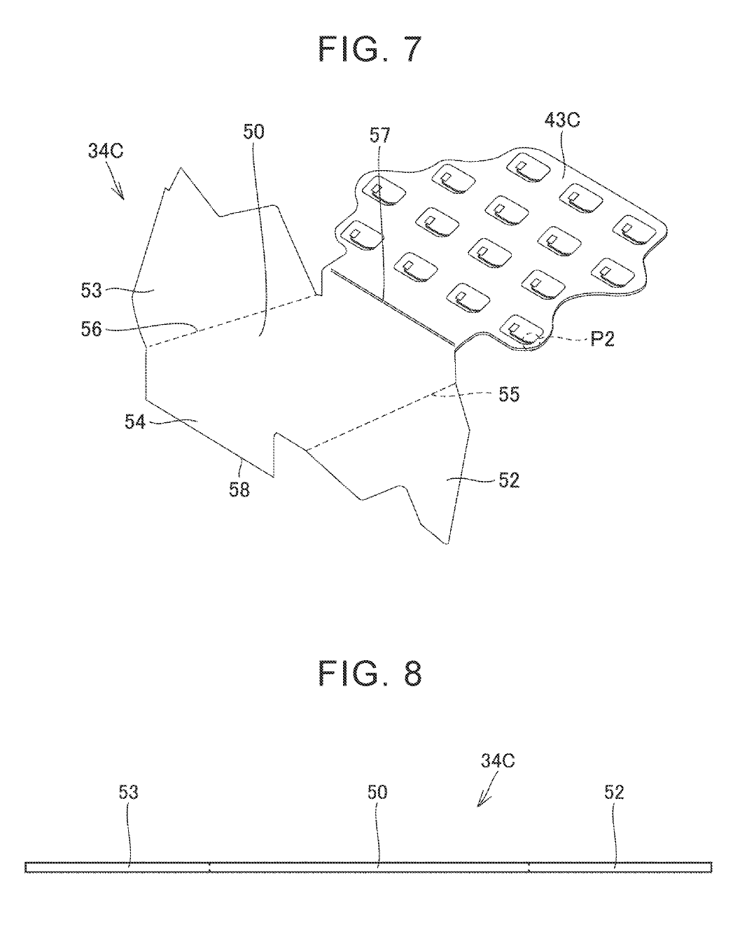

FIG. 7 is a perspective view illustrating the positive bus bar 43C and the connection member 34C in a state where the connection member 34C is developed, and FIG. 8 is a bottom view of the connection member 34C in the state illustrated in FIG. 7 when it is viewed from the lower side.

The body portion 50 includes lateral sides 55, 56, an upper hem 57, and a lower hem 58. The piece portion 52 is connected to the lateral side 55 and is provided so as to extend from the lateral side 55. The piece portion 53 is connected to the lateral side 56 and is provided so as to extend from the lateral side 56. A joining piece 54 is provided in the lower hem 58 of the body portion 50.

A shape of the piece portion 52 and a shape of the piece portion 53 are generally the same shape. A difference between a surface area of the piece portion 52 and a surface area of the piece portion 53 is not more than 10% of the surface area of the piece portion 52. In some embodiments, the difference is not more than 5% of the surface area of the piece portion 52.

Referring back to FIG. 4, in a state where the piece portions 52, 53 are folded, the piece portion 52 and the piece portion 53 approach each other. In the state where the piece portion 52 and the piece portion 53 are folded, most of the body portion 50 is covered with the piece portions 52, 53. In the meantime, the joining piece 54 projects from the piece portions 52, 53. Referring back to FIG. 3, the connection member 34C is placed on the lateral face of the inner case 32 and the joining piece 54 projects downward from the lower end of the inner case 32.

Similarly to the connection member 34C, the connection members 34B, 34D, 34E also include body portions and extension pieces. The connection member 34B is provided integrally with the positive bus bar 43B. The connection member 34D is provided integrally with the positive bus bar 43D.

The connection member 34E is provided so as to reach an end surface of the inner case 32 from the lateral face of the inner case 32. The connection member 34E is connected to an external connection terminal 39 provided on the end surface of the inner case 32.

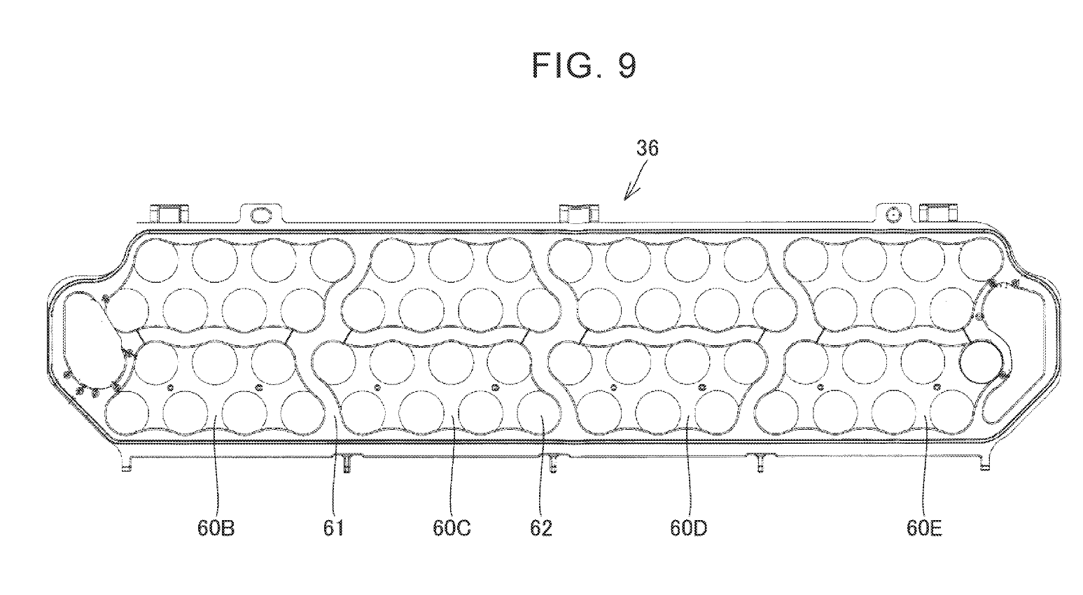

The negative bus bar module 36 is placed below the holder 30. FIG. 9 is a bottom view illustrating the negative bus bar module 36.

The negative bus bar module 36 includes a plurality of negative bus bars 60B, 60C, 60D, 60E, and a resin portion 61. The negative bus bars 60B, 60C, 60D, 60E are made of copper, copper alloy, or the like. The negative bus bars 60B, 60C, 60D, 60E are arranged in one direction, similarly to the positive bus bars.

The resin portion 61 integrally fixes the negative bus bars 60B, 60C, 60D, 60E and electrically insulates adjacent ones of the negative bus bars 60B, 60C, 60D, 60E from each other. A plurality of holes 62 is provided in each of the negative bus bars 60B, 60C, 60D, 60E.

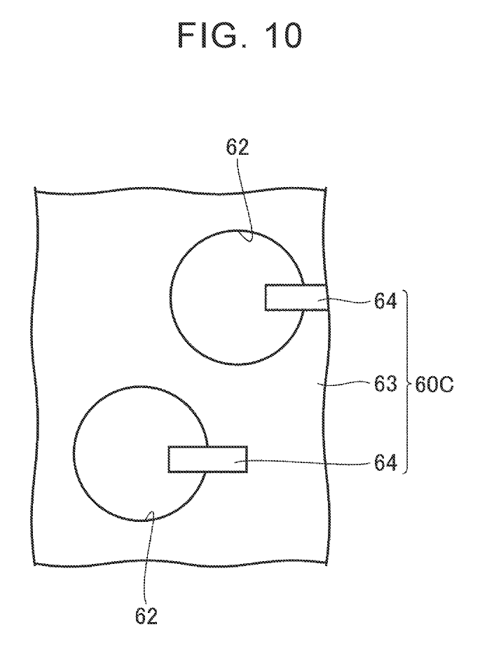

FIG. 10 is a plan view illustrating a part of the negative bus bar 60C. The negative bus bar 60C includes a bus bar body 63 and a plurality of terminal wiring lines 64. The bus bar body 63 is formed in a plate shape.

A plurality of holes 62 is provided in the bus bar body 63 such that the terminal wiring lines 64 are provided in the holes 62. A first end of the terminal wiring line 64 is welded to a bottom face of the bus bar body 63 and a second end of the terminal wiring line 64 is placed inside the hole 62. The second end of the terminal wiring line 64 is welded to the negative electrode 42 of the cylindrical cell 31. The terminal wiring lines 64 are connected to the negative electrodes 42, so that the negative electrodes 42 of the cylindrical cells 31 are connected in parallel to each other by the negative bus bar 60C.

Note that a sectional area of the terminal wiring line 46 of the positive bus bar 43C is smaller than a sectional area of the terminal wiring line 64 of the negative bus bar 60C. More specifically, a sectional area of the terminal wiring line 46 on a section perpendicular to the extension direction of the terminal wiring line 46 is smaller than a sectional area of the terminal wiring line 64 in a direction perpendicular to the extension direction of the terminal wiring line 64. More specifically, a sectional area of the wiring line 49 of the terminal wiring line 46 is smaller than the sectional area of the terminal wiring line 64.

When a current amount to flow in and out from the cylindrical cell 31 reaches a predetermined amount or more, the wiring line 49 of the positive bus bar 43C is fused and cut, so that the cylindrical cell 31 can be protected.

Referring back to FIG. 3, the negative bus bar module 36 is provided with a plurality of joining pieces 59B, 59C, 59D, 59E. The joining pieces 59B, 59C, 59D, 59E are provided at intervals on a lateral side of the negative bus bar module 36. The joining piece 59B is integrally connected to the negative bus bar 60B, and the joining piece 59B and the negative bus bar 60B are also electrically connected to each other. Similarly, the joining pieces 59C, 59D, 59E are connected to the negative bus bars 60C, 60D, 60E, respectively.

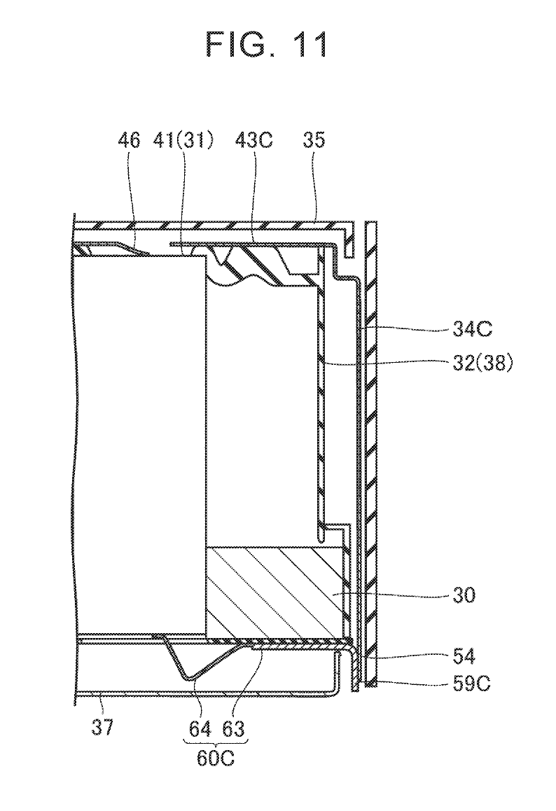

FIG. 11 is a sectional view illustrating a part of the power storage module 12. The positive bus bar 43C is provided on the upper wall portion of the inner case 32 such that the connection member 34C extends downward along the peripheral wall portion 38 of the inner case 32, and the joining piece 54 projects downward from a bottom face of the holder 30.

The joining piece 59C is provided so as to extend downward from a lateral side of the negative bus bar 60C and the joining piece 54 of the connection member 34C is joined to the joining piece 59C.

Referring back to FIG. 3, the joining piece 59B of the negative bus bar 60B is joined to the connection member 34B, and the joining piece 59D of the negative bus bar 60D is joined to the connection member 34D.

As a result, the negative electrodes of the cylindrical cells 31 connected in parallel to each other by the negative bus bar 60B are connected in series to the positive electrodes of the cylindrical cells 31 connected in parallel to each other by the positive bus bar 43B. Similarly, the negative electrodes of the cylindrical cells 31 connected in parallel to each other by the negative bus bar 60C are connected in series to the positive electrodes of the cylindrical cells 31 connected in parallel to each other by the positive bus bar 43C.

Thus, in the power storage module 12, a set of the cylindrical cells 31 connected in parallel to each other is sequentially connected in series to another set of the cylindrical cells 31 connected in parallel to each other.

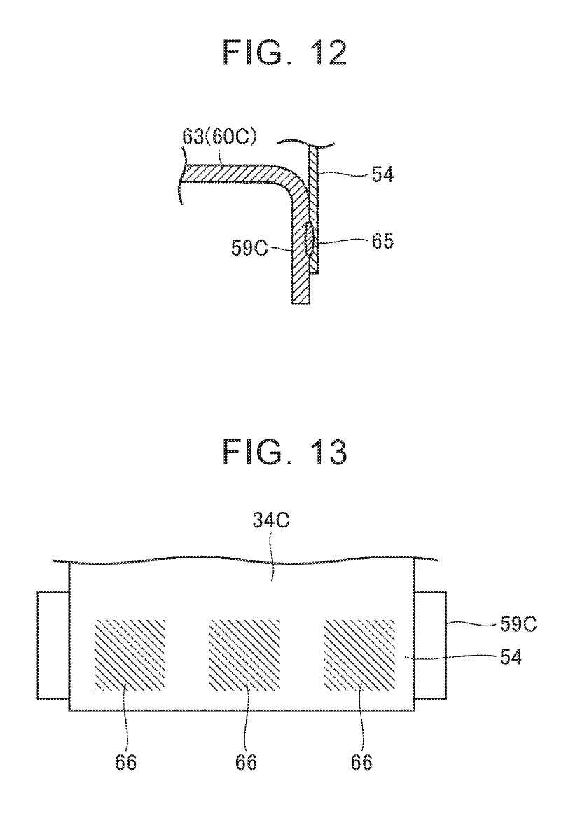

Next will be described configurations of the joining piece 59C and the joining piece 54 in detail. FIG. 12 is a sectional view illustrating the joining piece 59C and the joining piece 54. The joining piece 59C and the joining piece 54 are joined to each other by a welded portion 65. In the present embodiment, the joining piece 54 is joined to the joining piece 59C by ultrasonic welding.

FIG. 13 is a front view illustrating the joining piece 54 and the joining piece 59C. A plurality of pressing marks 66 is provided on a surface of the joining piece 54. The pressing mark 66 is a mark formed when ultrasonic welding is performed on the joining piece 59C and the joining piece 54.

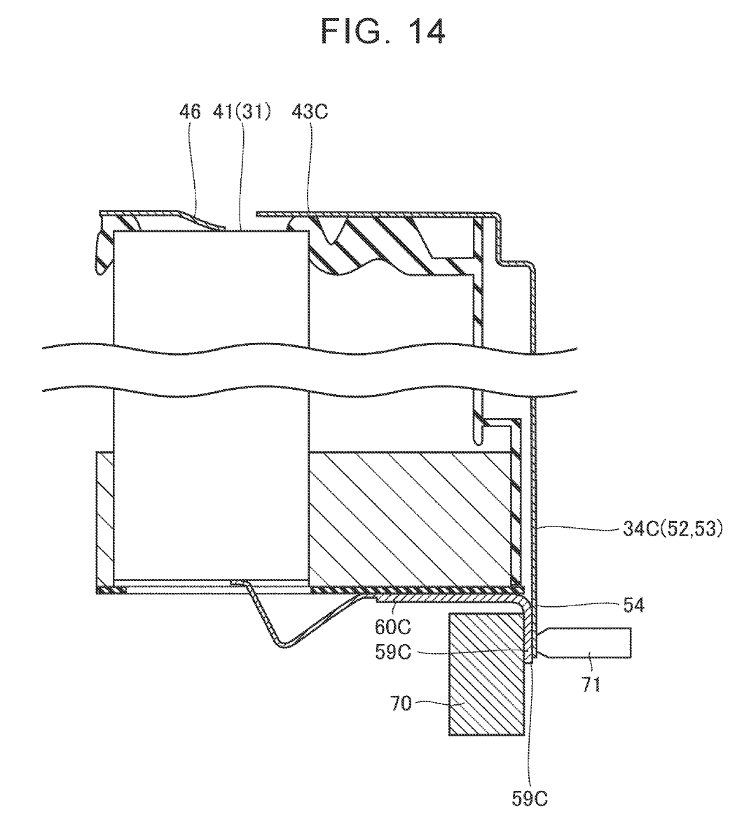

FIG. 14 is a sectional view illustrating a step of performing ultrasonic welding on the joining piece 59C and the joining piece 54. As illustrated in FIG. 14, the joining piece 59C is placed on a support base 70, and the joining piece 54 is placed on the joining piece 59C.

In this state, a distal end of a horn 71 of an ultrasonic welder is pushed against the joining piece 54, so that the joining piece 59C and the joining piece 54 are sandwiched between the support base 70 and the horn 71. When the horn 71 is driven, the distal end of the horn 71 vibrates. Hereby, the joining piece 59C and the joining piece 54 are rubbed by a pressing portion of the horn 71, so that the welded portion 65 is formed as illustrated in FIG. 12. Thus, as illustrated in FIG. 13, the pressing marks 66 are provided on the surface of the joining piece 54.

As illustrated in FIG. 14, at the time when the joining piece 59C and the joining piece 54 are welded to each other, the terminal wiring line 46 of the positive bus bar 43C is welded to the positive electrode 41 of the cylindrical cell 31. On this account, when ultrasonic welding is performed on the joining piece 59C and the joining piece 54, vibrations are applied to the joining piece 54.

Since the connection member 34C is provided with the piece portion 52 and the piece portion 53, the connection member 34C is restrained from vibrating.

The terminal wiring line 46 is thin, and therefore, when vibrations are applied to the terminal wiring line 46, the terminal wiring line 46 may break. However, as described above, the connection member 34C is restrained from vibrating, so that the bus bar body 47C and the terminal wiring line 46 can hardly vibrate, thereby making it possible to restrain breaking of the terminal wiring line 46. Details of the vibration prevention effect by the piece portions 52, 53 will be described later.

The thickness of the connection member 34C is thinner than the thickness of the negative bus bar 60C and the joining piece 59C. The thickness of the connection member 34C is not less than 1 mm but not more than 2 mm, for example. The thickness of the negative bus bar 60C and the joining piece 59C is not less than 3 mm but not more than 4 mm, for example.

As such, when the thickness of the connection member 34C is thin, vibrations can be hardly transmitted thereto as compared to a case where the thickness of the connection member 34C is thick, and the vibrations applied to the joining piece 54 can be restrained from being transmitted to the positive bus bar 43C. Next will be described the vibration prevention effect by the piece portions 52, 53 in detail.

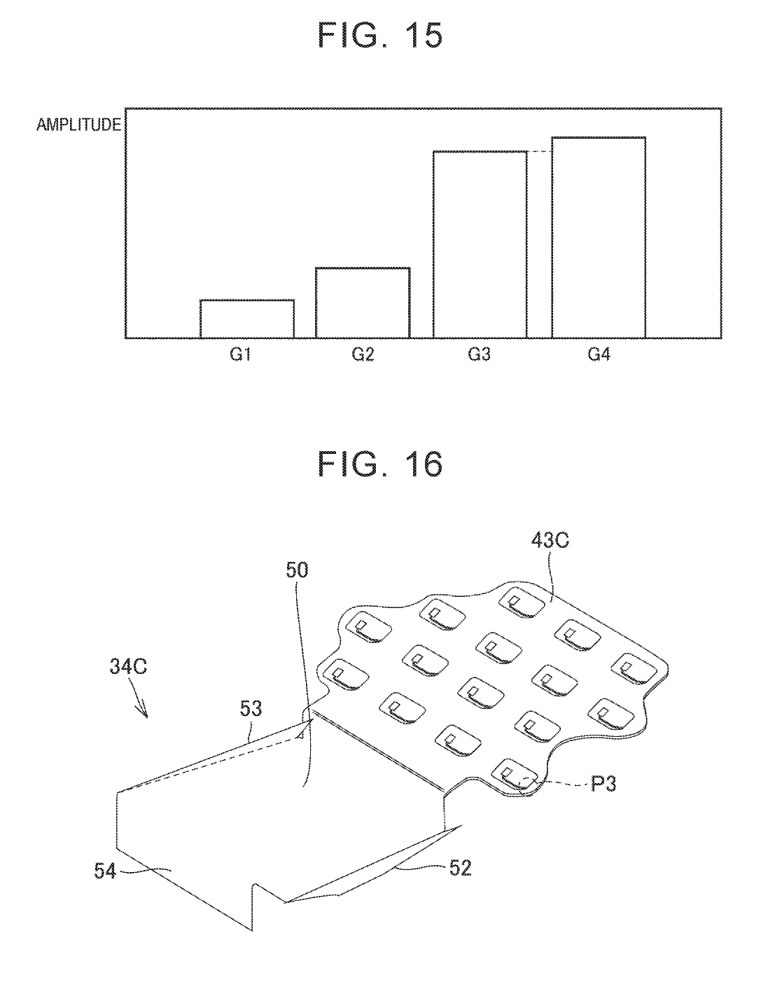

Various positive bus bars 43C were prepared and joining pieces 54 of the positive bus bars 43C were joined to respective joining pieces 59C by ultrasonic welding. FIG. 15 is a graph illustrating a result of measurement of an amplitude of vibration at each measurement point on the positive bus bars 43C.

The vertical axis of the graph in FIG. 15 indicates an amplitude of vibration (mm) caused at a measurement point. A graph G1 indicates an amplitude of vibration caused at a measurement point P1 at the time when the joining piece 54 of the connection member 34C in the state illustrated in FIG. 4 was joined to the joining piece 59C by ultrasonic welding.

A graph G2 indicates an amplitude of vibration caused at a measurement point P2 at the time when the joining piece 54 of the connection member 34C in the state illustrated in FIGS. 7 and 8 was joined to the joining piece 59C by ultrasonic welding.

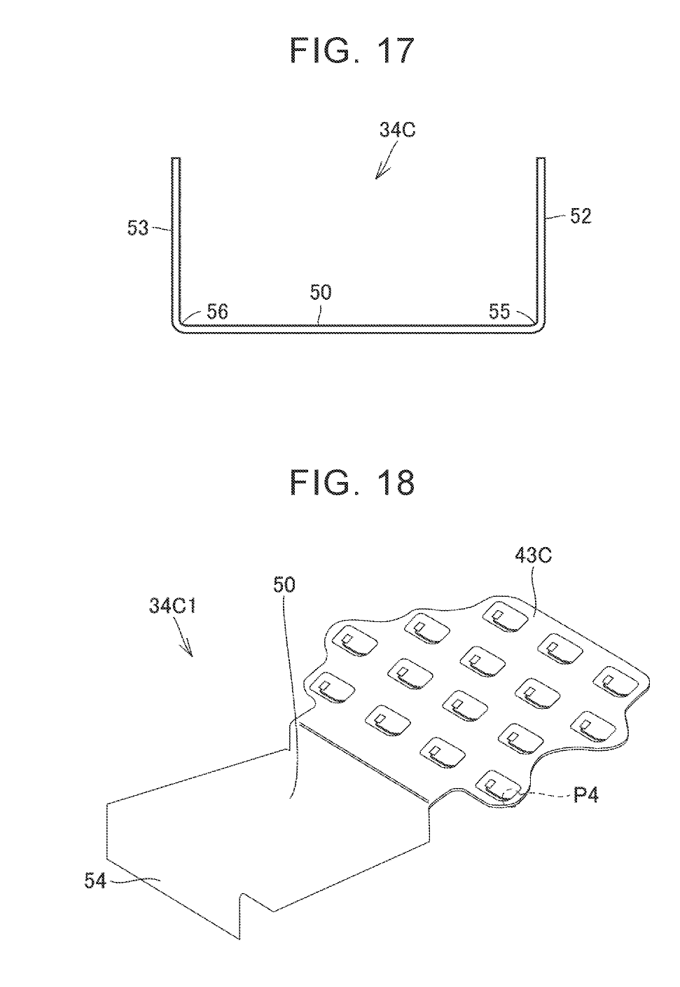

A graph G3 indicates an amplitude of vibration caused at a measurement point P3 at the time when the joining piece 54 of the connection member 34C in the state illustrated in FIGS. 16 and 17 was joined to the joining piece 59C by ultrasonic welding.

Note that the connection member 34C illustrated in FIGS. 16 and 17 is configured such that the piece portions 52, 53 stand so as to be perpendicular to the body portion 50.

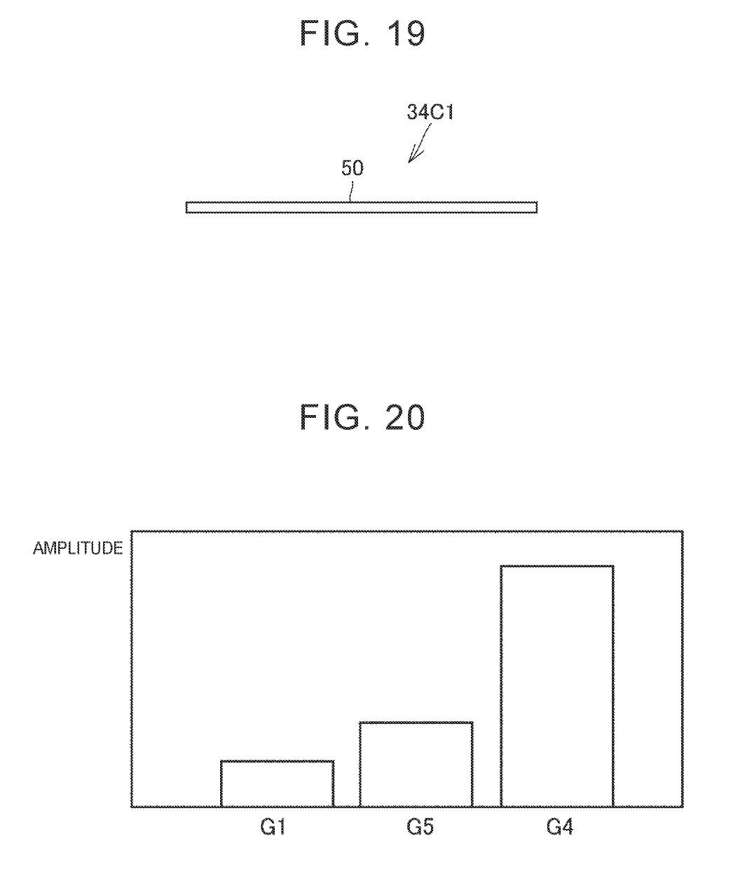

The connection member 34C 1 is illustrated in FIGS. 18 and 19. A graph G4 indicates an amplitude of vibration caused at a measurement point P4 at the time when the joining piece 54 of the connection member 34C1 was joined to the joining piece 59C by ultrasonic welding. Note that the piece portions 52, 53 are not provided in the connection member 34C 1 illustrated in FIGS. 18 and 19.

As illustrated in the graph G4 in FIG. 15, it is found that the amplitude is largest in the connection member 34C 1 that is not provided with the piece portions 52, 53. In the meantime, as apparent from the graphs G1, G2, G3, it is found that, when the piece portions 52, 53 are provided in the connection member 34C, the amplitude of vibration at each of the measurement points P1, P2, P3 is small.

That is, it is considered that, when the piece portions 52, 53 are provided in the connection member 34C, vibrations of the connection member 34C can be restrained, thereby resulting in that the amplitude of vibration to be transmitted to the positive bus bar 43C can be reduced.

Further, it is found that, as a folding angle of the piece portions 52, 53 to the body portion 50 is made smaller, the amplitude of vibration caused in the positive bus bar 43C can be made smaller. That is, the folding angle of the piece portions 52, 53 to the body portion 50 is 180 degrees or less, and in some embodiments 90 degrees or less.

Particularly, as illustrated in FIG. 4, it is found that, when the piece portions 52, 53 are folded so as to overlap with the extension piece 51, a large vibration prevention effect can be obtained.

Next will be described a relationship between the magnitude of each of the piece portions 52, 53 and the vibration prevention effect. FIG. 20 is a graph illustrating the relationship between the magnitude of each of the piece portions 52, 53 in various shapes and the vibration prevention effect. The vertical axis of the graph in FIG. 20 indicates an amplitude of vibration at each measurement point.

Note that the graphs G1, G4 illustrated in FIG. 20 are the same as the graphs G1, G4 illustrated in FIG. 15.

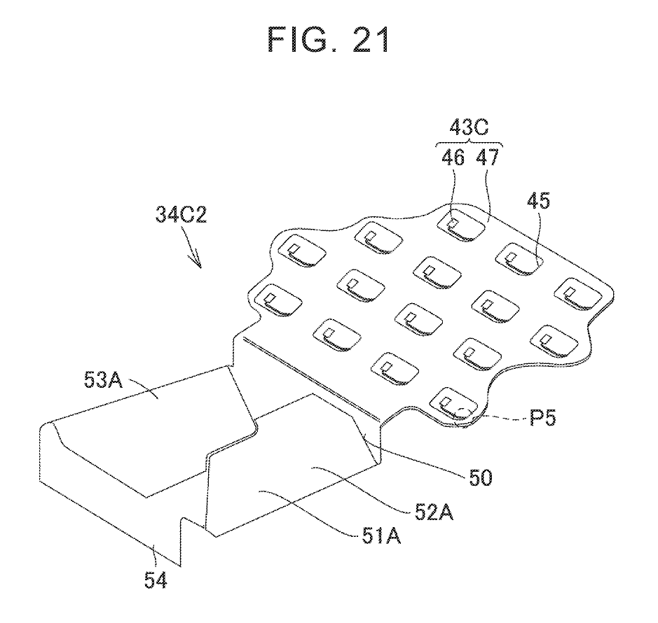

A graph G5 indicates an amplitude of vibration caused at a measurement point P5 at the time when the joining piece 54 of a connection member 34C2 illustrated in FIG. 21 is joined to the joining piece 59C by ultrasonic welding.

The connection member 34C2 includes the body portion 50 and an extension piece 51A. The extension piece 51A includes a piece portion 52A and a piece portion 53A. The piece portions 52A, 53A are formed by cutting distal ends of the piece portions 52, 53. The piece portion 52A and the piece portion 53A approach each other.

A surface area of the piece portion 52A is around 70% of the surface area of the piece portion 52, and a surface area of the piece portion 53A is around 70% of the surface area of the piece portion 53. As apparent from the graph illustrated in FIG. 20, it is found that the vibration prevention effect by the piece portions 52, 53 can be obtained as the magnitude of each of the piece portions 52, 53 is larger.

The connection member 34C and the positive bus bar 43C have been described in more detail, but the other connection members 34B, 34D, 34E and the other positive bus bars 43B, 43D, 43E are also provided similarly to the connection member 34C and the positive bus bar 43C, and the same vibration prevention effect as the connection member 34C and the positive bus bar 43C can be obtained.

As such, with the power storage device 5 of the present embodiment, it is possible to restrain breaking and the like of the terminal wiring line 46 at the time when the connection member is joined to the negative bus bar.

Note that the above embodiment deals with an example in which the connection members 34B, 34C, 34D are integrally connected to the positive bus bars 43B, 43C, 43D. However, the negative bus bars and the connection members 34B, 34C, 34D may be provided integrally. In this case, the connection members 34B, 34C, 34D are joined to the positive bus bar 43B, 43C, 43D.

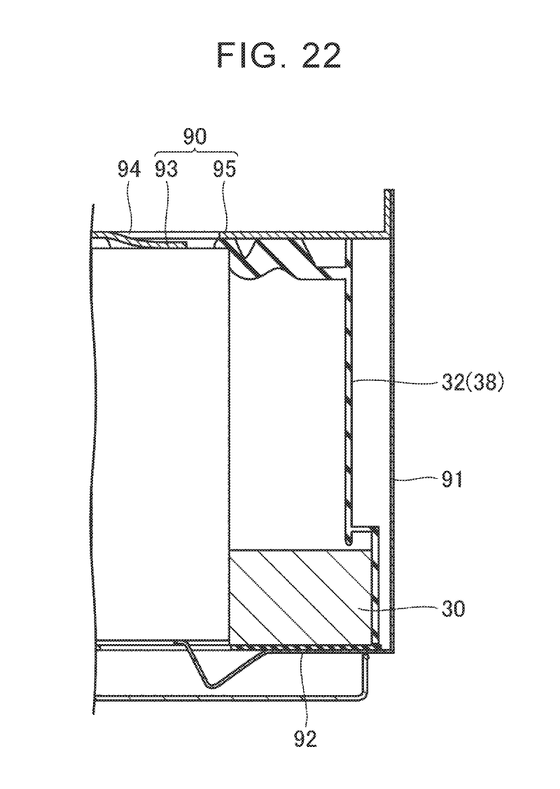

FIG. 22 is a sectional view illustrating a power storage device 5A of a modification of the power storage device of the present embodiment. The power storage device 5A includes a positive bus bar 90, a connection member 91, and a negative bus bar 92.

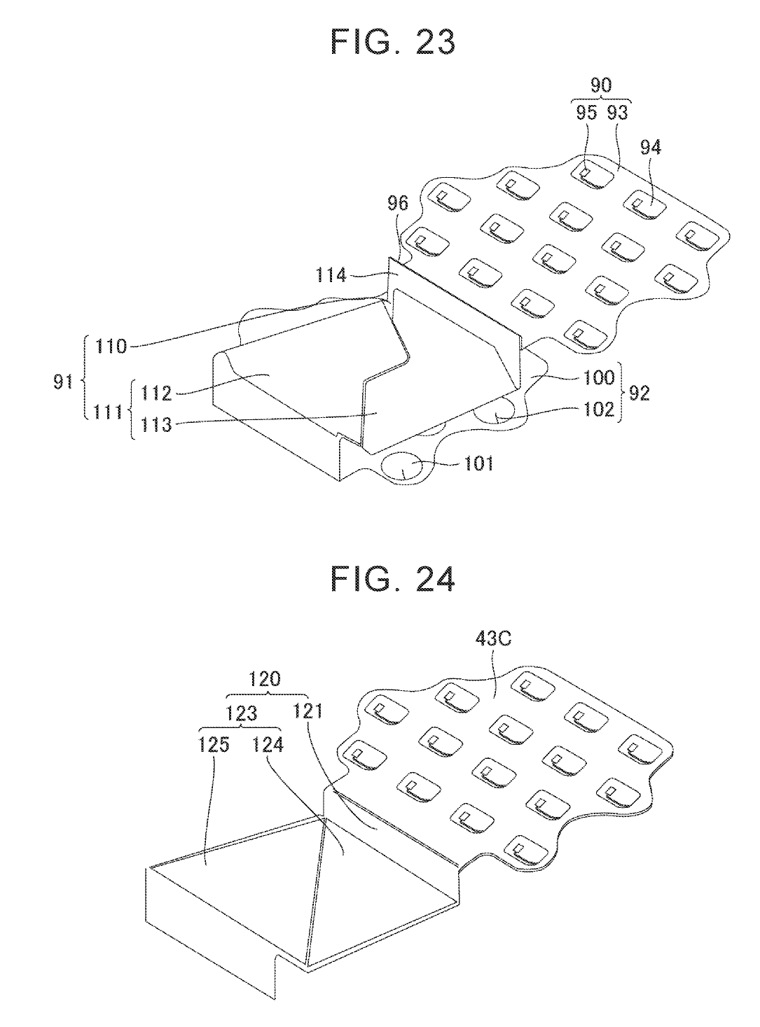

FIG. 23 is a perspective view illustrating the positive bus bar 90, the connection member 91, and the negative bus bar 92. The positive bus bar 90 includes a bus bar body 93, a plurality of connection terminals 95, and a joining piece 96. A plurality of holes 94 is provided in the bus bar body 93, and the connection terminals 95 are provided in the holes 94.

The joining piece 96 is provided on a lateral side of the positive bus bar 90 such that the joining piece 96 extends upward from the lateral side of the positive bus bar 90.

The negative bus bar 92 includes a bus bar body 100 and a plurality of terminal wiring lines 102. A plurality of holes 101 is provided in the bus bar body 100 and the terminal wiring lines 102 are provided in respective holes 101. Note that, in the power storage device 5A, the terminal wiring line 102 of the negative bus bar 92 is thinner than the connection terminal 95 of the positive bus bar 90.

The connection member 91 includes a body portion 110 and an extension piece 111. The extension piece 111 includes a piece portion 112 and a piece portion 113.

The piece portions 112, 113 are provided so as to extend from a lateral side of the body portion 110. The piece portions 112, 113 are folded so as to overlap with the body portion 110.

Here, the connection member 91 is provided integrally with the negative bus bar 92. More specifically, the connection member 91 is connected to a lateral side of the negative bus bar 92 so as to extend upward from the lateral side of the negative bus bar 92.

A joining piece 114 is provided in an upper end of the body portion 110, and the joining piece 114 and the joining piece 96 are joined to each other.

When the connection member 91 is joined to the positive bus bar 90, a horn is pushed against the joining piece 114 in a state where the joining piece 96 is supported by a support base, and ultrasonic welding is performed on the joining piece 114 and the joining piece 96.

At this time, vibrations applied to the joining piece 114 are restrained by the piece portions 112, 113, thereby making it possible to restrain the vibrations from being applied to the negative bus bar 92. This makes it possible to restrain adverse effects such as breaking of the terminal wiring line 102.

Note that, in the above embodiment and the above modification, the piece portions of the connection member are provided on lateral sides of the body portion of the connection member, but positions where the piece portions are formed are not limited to the above positions.

FIG. 24 is a perspective view illustrating a connection member 120 that is a further modification of the connection member of the power storage device of the modification. The connection member 120 includes a body portion 121 and an extension piece 123. The extension piece 123 includes a piece portion 124 and a piece portion 125.

The piece portion 124 is provided near an upper hem of the body portion 121, and the upper hem of the piece portion 124 is welded to the body portion 121. The piece portion 125 is connected to the body portion 121 below the piece portion 124, and a lower hem of the piece portion 125 is welded to the body portion 121.

When the piece portions 124, 125 are provided as such, it is possible to restrain vibrations from being applied to the positive bus bar at the time of ultrasonic welding.

The relationship of the following parts described in the embodiment of the disclosure with parts in the disclosure will be described as follows. The “cylindrical cell” of the present embodiment is an example of an “electrode cell” of the disclosure. The “positive bus bar” of the present embodiment is an example of a “first electrode bus bar” of the disclosure. The “negative bus bar” of the present embodiment is an example of a “second electrode bus bar” of the disclosure. The “terminal wiring line 46” of the present embodiment is an example of a “first terminal wiring line” of the disclosure. The “terminal wiring line 64” of the present embodiment is an example of a “second terminal wiring line” of the disclosure. The “piece portion 52” of the present embodiment is an example of a “first piece portion” of the disclosure. The “piece portion 53” of the present embodiment is an example of a “second piece portion” of the disclosure.

It should be considered that the embodiment described herein is just an example in all respects and is not limitative. The scope of the disclosure is shown by Claims and is intended to include all modifications made within the meaning and scope equivalent to Claims. Further, the values and the like are examples, and the disclosure is not limited to the values and the range.

What is claimed is:

1. A power storage device comprising:
an electrode cell including a first electrode and a second electrode;
a first electrode bus bar connected to the first electrode;
a second electrode bus bar connected to the second electrode; and
a connection member connected to the first electrode bus bar and joined to the second electrode bus bar, the connection member including a body portion connected to the first electrode bus bar and joined to the second electrode bus bar, and an extension piece provided so as to extend from the body portion, the extension piece being folded from the body portion.

2. The power storage device according to claim 1, wherein the extension piece is folded so as to overlap with the body portion.

3. The power storage device according to claim 1, wherein:
the first electrode bus bar includes a first terminal wiring line connected to the first electrode;
the second electrode bus bar includes a second terminal wiring line connected to the second electrode; and
the connection member is integrally connected to the first electrode bus bar.

4. The power storage device according to claim 3, wherein:
a sectional area of the first terminal wiring line is smaller than a sectional area of the second terminal wiring line; and
a thickness of the connection member is thinner than a thickness of the second electrode bus bar.

5. The power storage device according to claim 1, wherein:
the body portion includes a first lateral side and a second lateral side; and
the extension piece includes a first piece portion and a second piece portion, the first piece portion being connected to the first lateral side and provided so as to extend from the first lateral side, the second piece portion being connected to the second lateral side and provided so as to extend from the second lateral side.
